(19) United States
(12) Patent Application Publication
(10) Pub. No.: US 2026/0086507 A1
(43) Pub. Date: Mar. 26, 2026

(54) Apparatus for the Secure Processing of Data

(71) Applicant: SICK AG, Waldkirch (DE)

(72) Inventors: Pascal LIEGIBEL, Waldkirch (DE); Thomas NEUMANN, Schallstad (DE); Christoph HOFMANN, Waldkirch (DE); Heiko STEINKEMPER, Waldkirch (DE)

(21) Appl. No.: 19/303,871

(22) Filed: Aug. 19, 2025

(30) Foreign Application Priority Data
Aug. 29, 2024 (EP) 24197367.6

(51) Int. Cl. G05B 9/02

(52) U.S. Cl. CPC G05B 9/02

(57) ABSTRACT

An apparatus for use in an industrial environment, in particular an industrial machine, for the secure processing of data within a software container environment includes a data generating unit for generating application data and a data processing unit for processing the application data. The data processing unit, as a runtime environment, is configured to allow a plurality of logic modules to run on the data processing device. The logic modules include: at least one application module for executing at least one application using the application data and is configured to generate state data associated with the application; an adaptation module configured to receive the state data and to convert the state data into a format that is processable for a safety monitoring module configured to receive the converted state data from the adaptation module and to determine whether an error state exists on the basis of the converted state data.

The invention relates to an apparatus for use in an industrial environment, in particular an industrial machine, for the secure processing of data within a software container environment and to a safety method and to a computer readable storage medium.

The development of safety-oriented applications places high demands on the compliance with strict safety and reliability standards. These requirements become even more complex if the application is to be operated in a modern, containerized environment such as Kubernetes. Kubernetes, as application-independent orchestration software, offers numerous advantages with respect to the scalability, flexibility and management of containers. However, Kubernetes lacks specific mechanisms to support the safety-critical requirements of applications. This presents developers with the challenge of ensuring that their applications can run not only functionally, but also securely and reliably in a Kubernetes infrastructure. Secure orchestration platforms, such as are, for example, described as secure Kubernetes in the patent applications EP 439 05 77 A1, EP 241 76 635 A1 or EP 241 76 655 A1, which are incorporated herein by reference in their entirety for all purposes, go beyond the basic safety features of Kubernetes and provide additional safety mechanisms to support safety-critical applications and workloads.

So that an application can use the security infrastructure of a secure orchestration platform, it is, however, essential to already consider the specific requirements of such services in the early phase of application development. A subsequent integration of an application into the security infrastructure of such services requires considerable changes to the existing program code and leads to increased costs and delays.

It is thus an object of the present invention to address this problem and to provide an apparatus for use in an industrial environment that offers increased flexibility in the development of applications.

This object is satisfied by the subjects of the independent claims.

A first aspect of the invention relates to an apparatus for use in an industrial environment, in particular an industrial machine, for the secure processing of data within a software container environment, said apparatus comprising:
a data generating unit for generating application data,
a data processing unit for processing the application data provided by the data generating unit within the software container environment, wherein the data processing unit, as a runtime environment, is configured to allow a plurality of logic modules to run on the data processing unit, wherein the logic modules comprise:
   at least one application module for executing at least one application using the application data, wherein the application module is configured to generate state data that are associated with the application,
   an adaptation module that is configured to receive the state data from the application module and to convert the state data into a format that is processable for a safety monitoring module, and
   the safety monitoring module that is configured to receive the converted state data from the adaptation module and to determine whether an error state exists on the basis of the converted state data.

In other words, the adaptation module represents an interface between the application module and the safety monitoring module, which interface converts the state data sent by the application module into a format that can be processed by the safety monitoring module. This is in particular advantageous if the state data have a form that cannot be processed by the safety monitoring module. With the help of the adaptation module, each application can thus be adapted to the requirements of the safety monitoring module, in particular also subsequently.

The term software container environment, for example, refers to an environment that makes it possible to execute software applications in so-called containers in an isolated and portable manner. Containers are lightweight, stand-alone packets that contain everything needed to execute the software, including the software code, the runtime, the libraries and the settings. This environment offers a plurality of advantages, including isolation, consistency and efficiency in the provision and management of applications. Container environments such as Docker are well known. Container orchestration systems such as Kubernetes are as a rule used to manage and operate a plurality of containers. Such container orchestration systems usually do not have safety monitoring implementations aimed at securely operating the container orchestration in safety-critical or highly regulated environments. However, a respective container orchestration system can, for example, be extended by diagnostic units or additional safety monitoring mechanisms, such as shown in EP 439 05 77 A1, in order to become a secure orchestration platform. In particular, such safety monitoring implementations include measures that are taken to ensure the security, reliability and compliance with specifications when using the orchestration software.

In such environments, the invention makes it possible to adapt an application to the requirements of the safety monitoring module, in particular also subsequently, by means of the adaptation module in order to make use of the advantages of secure orchestration platforms. For example, the safety monitoring module is implemented according to the requirements of the respective secure orchestration platform so that the state data are adapted to these requirements by the adaptation module. A time-consuming adaptation of the code of the application module or an early consideration of the predefined requirements of the safety monitoring module or of the security infrastructure of the safety monitoring module is thus not necessary.

In the following, the term industrial machine is indeed used to describe the invention; however, the corresponding statements also refer to an apparatus for use in an industrial environment. The industrial machine can be configured for use in industrial production processes. For example, the industrial machine is adapted to perform tasks such as production, processing, assembly, transport, packaging or quality assurance. The industrial machine can further be operated in a manually controlled manner, fully automated manner or semi-automated manner. An industrial machine can in particular comprise a robot, e.g. an AMR (Autonomous Mobile Robot) or AGV (Automated Guided Vehicle), an edge computing device, a storage system, in particular an automated storage system, a conveying system, a production system and the like.

The processing unit in this respect acts as a runtime environment. The processing unit is thus the structural element and the runtime environment is the function of said structural element. The processing unit is at least indirectly connected to the data generating unit. It therefore has access to the application data for their processing, possibly indirectly via intermediate further units, and can then, for example, act via a machine control of the industrial machine or directly on the industrial machine.

A plurality of logic modules run on the data processing unit during the operation of the industrial machine. The data processing unit can comprise at least one computing apparatus and one memory. For example, the data processing apparatus is a computer, for example a host computer, a microcontroller, a cloud computing platform or the like. A logic module generally refers to a software function block. Software function blocks are in particular independent, self-contained units within a software program that implement a specific function or a group of functions. A logic module can, for example, be designed as a container that runs within Kubernetes.

The application module, the adaptation module and/or the safety monitoring module can be implemented in individual containers or in a common container. Advantageously, the adaptation module can be easily integrated into existing software applications by implementing it at an interface between the application module and the safety monitoring module. In particular, the integration into an existing system can also take place subsequently, wherein the adaptation module can be adapted to the software technologies used by the industrial machine. The applications can also be pure software applications that have the aim of processing, converting or preparing data. In particular, the applications are, however, coupled with further applications, i.e. applications exchange data with one another such that they are part of an overall application that has a detectable effect in the industrial machine and in the real world.

According to the invention, one of the logic modules is configured as a safety monitoring module that in particular performs a safety-oriented evaluation of the state data. The aim of the safety-related evaluation is the recognition of an error state, i.e. a safety-relevant event or state. In the case of an error state, a safety signal is preferably output in order to trigger a safety-related reaction of the industrial machine with which the machine is put into a safe state that eliminates a possible hazard or at least reduces it to an acceptable level.

For example, the industrial machine is a robot that, for example, uses the ROS framework (Robot Operating System) to develop robot software. For example, different applications of the robot can be implemented in different software containers (hereinafter only referred to as “containers”). However, the industrial machine can also be a vehicle, a camera system or any other machine that processes application data to execute an application within a software container environment.

The application data, i.e. use data, are in this respect generated by a data generating unit. Such a data generating unit is, for example, a camera, a sensor or any other device that can generate data. In the case of a virtual application, the data generating unit can be a virtual data generating unit. For example, the data generating unit can be a virtual sensor.

The application data provided are used by the application module to execute an application. Application is in this respect understood as any type of computer-executable application. For example, the application can be any application that can be executed using a data processing unit on which the software code is implemented. An application can in this respect also be a partial application that represents only a part of an overall application, wherein at least the overall application has a direct sphere of influence in the real world. This in particular refers to applications in which the associated software code is modularized within software containers. Exemplary applications are: data filtering, sensor data processing, image recognition, person recognition or the like. In particular, the application can be any AI application including a neural network, generative AI or an AI microservice such as NIM (Nvidia Inference Microservices).

When the application is executed, state data that are associated with the application are also generated by the application module. The state data can reflect a state of the application. For example, the state data can indicate whether an application is executed without errors or whether an error state exists that requires the execution of a safety function. The application module is in particular able to transmit data, e.g. state data, via any desired message systems and/or message technologies such as DDS, HTTP, socket or the like.

The adaptation module receives these state data. However, since the safety monitoring module usually has predefined requirements for the format of the input data, the state data must be converted into a format that is processable for the safety monitoring module. The adaptation module carries out this conversion and transmits the converted state data to the safety monitoring module. For example, the adaptation module accepts state data that correspond to a predefined input format and outputs converted state data that correspond to a predefined output format. The adaptation module can accept and process a plurality of different input formats.

Further embodiments of the invention can be seen from the claims, from the description and from the drawings.

According to one embodiment, the application module, the adaptation module and the safety monitoring module are designed as part of an application component, in particular an independent application component. The application module, the adaptation module and/or the safety monitoring module in particular access the same resources. Independent here, for example, means that each application component is an isolated unit that has its own environment and resources. An application component can, for example, comprise one or more containers that exchange data with one another and interact with one another in order to realize a specific application, wherein the containers of an application component can communicate with containers of another application component, for example, via interfaces of the application components.

In particular, the application module, the adaptation module and/or the safety monitoring module access the same network and the same memory. For example, the application module, the adaptation module and/or the safety monitoring module run on the same host. If the application module, the adaptation module and the safety monitoring module are designed as part of a Kubernetes ecosystem, an application component can, for example, be a Kubernetes pod that is often used to host tightly coupled containers that have to work together. A Kubernetes Pod is the smallest and simplest unit in the Kubernetes ecosystem. For example, all the containers in a Kubernetes pod share a memory, an IP address and port assignments and can communicate with one another via the same host.

According to one embodiment, the application module and the adaptation module are implemented on the same container, wherein the adaptation module and the application module use the same software technologies. For example, the application module and the adaptation module use the same framework, system, the same programming library or programming paradigm and/or the same data structures and data types.

According to one embodiment, the application module and the adaptation module are implemented on different containers, wherein the adaptation module is adapted to the application module, in particular to the software technologies used by the application module, by means of adaptation mechanisms. For example, the adaptation module is adapted to the software technologies used by the application module by means of RPC (Remote Procedure Call) mechanisms. RPC mechanisms are in particular methods that enable a program to execute a process or a function in a different address space, i.e. in an environment in which, for example, a different software technology is used. RPCs can abstract the network communication and can provide a simple interface for the distributed application development.

This variant has the advantage of increased resilience if a plurality of application modules use the same adaptation module or exchange data with the same adaptation module. In addition, this variant can be implemented with less overhead and less latency. As already described, the software technologies can relate to a software framework, a software system, a programming library or a programming paradigm and/or data structures and data types.

According to one embodiment, the adaptation module is in communication with a plurality of different application modules and/or the adaptation module is used for a plurality of different applications. For example, the adaptation module can be used for a variety of applications as long as the applications are implemented according to the same technology platform, in particular the same technology framework or software framework. This is due, for example, to the fact that the adaptation module is adapted to the respective requirements posed by a technology platform. The adaptation module can, for example, process predefined data types and/or data formats that are used within the technology platform. The adaptation module can thus be in communication with a plurality of application modules that follow the rules and requirements of the technology platform and that convert state data of a respective application module in order to convert said state data into a format that is processable, i.e. readable, for the safety monitoring module.

If the industrial machine is, for example, a robot that uses the ROS framework, the adaptation module can be adapted to the ROS framework used by the robot and can, in particular only, be used in combination with the ROS framework. The adapter can be adapted accordingly for use within other frameworks.

According to one embodiment, the state data comprise state data packets. A state data packet can comprise at least one of the following: a state data packet ID, an application designation, a creation point in time of the state data packet, a verification sign, a sequence number, a type of the state data packet, a status of the state data packet or an attribute of the state data packet. The state data can, for example, be transmitted in the form of state data packets, also known as “heartbeats”, that indicate the state of the application, in particular for a specific point in time.

The state data packet ID is, for example, a unique identification number or identification sign by means of which the state data packet can be identified.

The application designation is, for example, a human-readable name for the application or a component of the application with which the state data packet is associated. For example, the state data packet can only specify the state of a component of the application, for example, a sub-function within the application.

The creation point in time of the state data packet in particular indicates the point in time at which the application created the state data packet.

By means of the verification sign, a correctness of the state data packet can be determined. For example, it can be determined whether the data contained in the state data packet are plausible and/or correspond to a specific format. The verification sign can, for example, be a hash value or a checksum that is generated on the basis of the data included in the state data packet or on the basis of at least a portion of the data contained in the state data packet. The verification sign can, for example, be determined using a function or a calculation rule that assumes the data contained in the state data packet as input values in order to determine the verification sign. Algorithms and/or functions such as MD5, SHA-1 or SHA-256 can be used for this purpose.

The sequence number is, for example, a consecutive number that specifies a creation sequence of the created state data packets. Based on the sequence number, the state data packets can thus be processed in chronological order by the adaptation module and/or a safety monitoring module.

The type of the state data packet is, for example, a specification that that specifies the state data packet in more detail. This is helpful in particular in cases where different types of state data packets exist. The type can, for example, specify the stage of a check with which the state data packet can be associated. Furthermore, the type of the state data packet can specify the parameter for which the state data packet indicates a state.

The status of the state data packet can further indicate whether the action associated with the state data packet was executed successfully or not. For example, the status can assume two different values, wherein the first value indicates a successful action, while the second value indicates a failed action. The status can thus be “failed” or “successful”. For example, the status can take on a Boolean value, wherein “true” indicates a successful action and “false” indicates a failed action. In particular, the safety monitoring module can be configured to determine whether there is an application error on the basis of the status of the state data packet.

The state data packet can further comprise one or more attributes or attribute fields that contain additional useful data. For example, an attribute can include a list with key/value pairs having application-specific attributes that describe the state data packet in more detail. Such an attribute can, for example, be a status code that describes the result of the processing in even more detail.

According to one embodiment, the application module is configured to generate the state data packets cyclically, wherein a predefined number of state data packets are generated within a cycle, wherein the state data packets of a same cycle have the same sequence number. In other words, the state data packets can be generated at fixed, regular intervals. A regular check of the state of the application can hereby take place so that faulty states can be recognized quickly. The frequency can vary depending on the requirements; for example, in systems with very high real-time requirements, the state data packets can be transmitted at time intervals of a few milliseconds, e.g. less than 100 ms, 50 ms, 10 ms or 5 ms. In other systems in which the requirements are lower, the time intervals between the state data packets can also be in the range of seconds. For example, the time interval can be less than 30 s, 10 s or 1 s.

According to a further embodiment, the application module is configured to generate at least two state data packets within a cycle, wherein at least one state data packet is of the “Processing started” type and at least one state data packet is of the “Processing completed” type. In particular, the application module generates a state data packet of the “Processing completed” type immediately after a state data packet of the “Processing started” type. A state data packet of the “Processing started” type thus initiates a new cycle, wherein a new sequence number is also assigned with each state data packet of the “Processing started” type. However, further state data packet types can also be included in a cycle that, for example, represent an intermediate step of a processing or an intermediate result. According to one embodiment, the adaptation module is configured to arrange the state data packets in a queue in an order that corresponds to the chronological arrival of the state data packets. The state data packets can thus be processed chronologically based on their position in the queue. For example, the state data packets can remain in the queue until a further processing is required or possible. In particular, the safety monitoring module can define the point in time at which a further processing of the state data packets is to take place. It is also possible for particularly safety-relevant state data packets to be placed in a first position in the queue so that they are processed with priority and before the other state data packets. In an embodiment in which the adaptation module is used for a plurality of applications, the state data packets of the different applications can be arranged chronologically in a single queue.

According to one embodiment, the adaptation module is configured, in response to an action signal that is received from the safety monitoring module and that comprises a processing ID, a sequence number and/or a verification sign, to check the state data packets that are associated with the sequence number stored in the action signal. The action signal thus triggers the processing of one or more associated state data packets. In particular, the action signal comprises only the processing ID, the sequence number and/or the verification sign, wherein no further metadata are included in the action signal. However, the further metadata for the state data packets can be stored in the safety monitoring module. Based on the data contained in the action signal, the associated state data packets can be unambiguously determined and selected from the queue in the adaptation module to start the checking of the state data packets.

According to one embodiment, the check comprises a preliminary check, wherein the preliminary check comprises: a first completeness check, wherein the completeness check is positive if a predefined number of associated state data packets are present for the sequence number, and negative if fewer than the predefined number of state data packets are present for the sequence number, wherein, in the event of a positive first completeness check, an evaluation of the state data packets takes place, wherein, in the event of a negative first completeness check, a predefined time period is waited until a second completeness check takes place, wherein, in the event of a positive second completeness check, an evaluation of the state data packets takes place, wherein, in the event of a negative second completeness check, the adaptation module is configured to send an error signal in a format that is readable for the safety monitoring module to the safety monitoring module.

For example, based on a comparison of the actual number of the state data packets selected from the queue based on the sequence number and the predefined number, it can be determined whether the state data packets associated with the sequence number are complete. In other words, it can be determined whether state data packets are missing. The predefined number results, for example, from the number of state data packets that are or should be created during a cycle. If no state data packets are missing, the state data packets can be evaluated in a next step. However, if state data packets are missing, a predefined time period is waited until a second completeness check is carried out. In addition, the adaptation module can transmit a standby signal to the safety monitoring module, wherein the standby signal indicates that the heartbeats that are associated with the sequence number specified in the action signal have not yet been completely processed. The safety monitoring module is thus informed that the processing of a corresponding action signal has not yet been completed so that no safety action is triggered for the time being. For example, after the first completeness check, a predefined number of action signals or cycles are waited until the second completeness check takes place. If the result of the second completeness check is likewise negative, i.e. if state data packets are still missing, an error signal is sent in a format that is readable for the safety monitoring module to the safety monitoring module. If the result of the second completeness check is positive, the state data packets can be evaluated in a next step.

As an alternative to the above embodiment, the preliminary check can also be designed such that the error signal is already sent to the safety monitoring module in the case of a negative first completeness check. In such a case, no second completeness check thus takes place. This can be the preferred embodiment in the case of particularly safety-critical applications in which there is only a small degree of tolerance.

According to one embodiment, the check of the state data comprises an evaluation, wherein the evaluation comprises: a plausibility check of at least one of the state data packets and/or a status check of at least one of the state data packets, wherein the adaptation module is configured, in the event of a failed plausibility check and/or a failed status check, to send an evaluation data packet in a format that is readable for the safety monitoring module to the safety monitoring module, wherein the evaluation data packet indicates an error state. If, on the other hand, the plausibility check and the status check are successful, i.e. do not fail, the adaptation module is configured to send an evaluation data packet in a format that is readable for the safety monitoring module to the safety monitoring module, wherein the evaluation data packet indicates that there is no error state. In the plausibility check, it can, for example, be checked whether the data of the state data packets are in a range that is typical for the respective data. Furthermore, for at least one data field of the state data packets, a predefined number of values which the data field can assume, can be known. If the actual field value of the data field does not match one of the predefined field values, the plausibility check for the respective state data packet may have failed.

According to one embodiment, the plausibility check of at least one of the state data packets comprises the following checks:
a check of the verification sign of the state data packet, which check comprises determining a comparison verification sign for the state data packet using the data of a state data packet and comparing the determined comparison verification sign with the verification sign of the state data packet,
a check of a plausibility of the creation point in time of the state data packet and/or
a check whether the number of state data packets exceeds or falls below a predefined number,
wherein the plausibility check is deemed to have failed if at least one of the checks included in the plausibility check fails for at least one of the state data packets.

With the check of the verification sign, for example, the correctness of the verification sign, which is stored in the state data packet and which can, as already described above, be a hash value or a checksum, is checked. In particular, with such a check, it is checked whether the data of the state packet data sent by the application module correspond to the data of the state data packet received by the adaptation module. The verification sign is namely generated based on the entire data included in the state data packet. For this purpose, a hash function can, for example, be used that accepts the entire data of the state data packet, with the exception of the verification sign, as input values and outputs a checksum or a hash value as the verification sign. A change of a data field in the state data packet would thus result in the verification sign also changing. Since the comparison verification sign is in particular calculated or determined according to the same rules as the verification sign, based on a comparison of the two signs, it can be determined whether the transmitted data of the state data packet match the received data of the state data packet or whether a manipulation of the corresponding data, for example in the form of data corruption, is present. If the determined comparison verification sign and the verification sign do not match, this represents an error state, for example, and the check is deemed to have failed.

A check of the plausibility of the creation point in time of the state data packet can further take place. Such a check, for example, comprises a check of the conclusiveness of the creation point in time or of the timestamp of the state data packet. In particular, it is checked whether the creation point in time does not include a negative value and/or whether the time base of the creation point in time matches the time base used by the adaptation module. If the check of the plausibility of the creation point in time is negative, i.e. fails, this represents an error state, for example, and the check is deemed to have failed.

The plausibility check can further comprise a check during which it is checked whether the number of state data packets exceeds or falls below a predefined number. In particular, it is checked whether the number of state data packets exceeds a predefined number since the case of the falling below has preferably already been checked in the preliminary check. However, it is also conceivable that the case of the falling below is likewise checked again in the plausibility check in order to create a certain redundancy that increases the security of the system. If the result of the check is that the number of state data packets exceeds or falls below a predefined number, this represents an error state, for example, and the check is deemed to have failed.

According to one embodiment, the status check comprises a check of the status of all the state data packets that are associated with the sequence number, wherein the status check is deemed to have failed if at least one of the state data packets has a “failed” status. The status indicates, for example, whether the action associated with the state data packet has been executed “successfully” or whether the action associated with the state data packet has “failed”. In other words, the status check is deemed to be “successful” if all the statuses of the state data packets are “successful”, i.e. none of the state data packets has a “failed” status.

In particular, in the case of a successful plausibility check and a successful status check, an evaluation data packet is sent to the safety monitoring module that indicates an error-free state. The evaluation data packet can comprise at least one of the following: a sender ID, a processing ID, a sequence number, an evaluation result or a verification sign. The sender ID is, for example, an identification symbol, for example in the form of a human-readable name, for the adaptation module and/or the application for which the adaptation module is used. The processing ID and the sequence number correspond, for example, to the processing ID and sequence number contained in the action signal that was transmitted by the safety monitoring module. The evaluation result indicates whether the state data packets associated with the sequence number indicate an error-free state or whether an error state exists. For example, the evaluation result can be specified as a Boolean value, wherein “true” indicates an error-free state of the state data packets and “false” indicates an error state. The verification sign of the evaluation data packet can be determined based on the data contained in the evaluation data packet, with the exception of the verification sign itself. The above statements on the verification sign of the state data packets apply accordingly.

A further aspect of the invention relates to a safety method for the secure processing of data within a software container environment, wherein the method comprises that:
application data are generated by a data generating unit,
on a data processing unit for processing the application data provided by the data generating unit within the software container environment, a plurality of logic modules run on the data processing unit, wherein the logic modules comprise an application module, an adaptation module and a safety monitoring module, state data that are associated with an application are generated by the application module,
the state data are received by the adaptation module and the state data are converted into a format that is processable for a safety monitoring module,
wherein the converted state data are received by the safety monitoring module and, on the basis of the converted state data, it is determined whether an error state exists.

A further aspect of the invention relates to a computer readable storage medium comprising commands that, on the execution by a computer, cause it to carry out the safety method according to any one of the preceding embodiments.

The above statements on the industrial machine apply accordingly to the safety method and to the computer-readable storage medium; this in particular applies with respect to advantages and embodiments.

Furthermore, any combination of the preceding embodiments is possible if this is not explicitly excluded.

The invention will be presented purely by way of example with reference to the drawings in the following. There are shown:

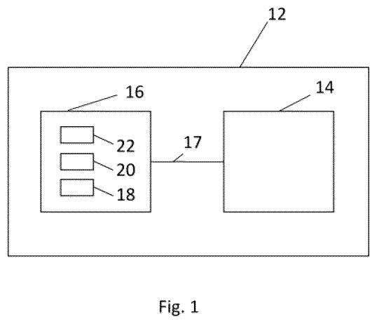

FIG. 1 an industrial machine according to an embodiment;

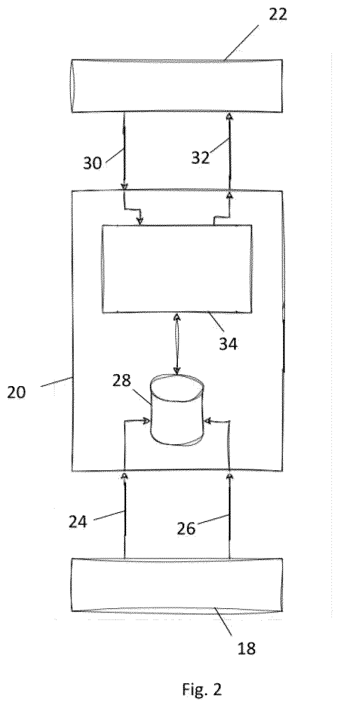

FIG. 2 a flowchart that illustrates a mode of operation of one embodiment;

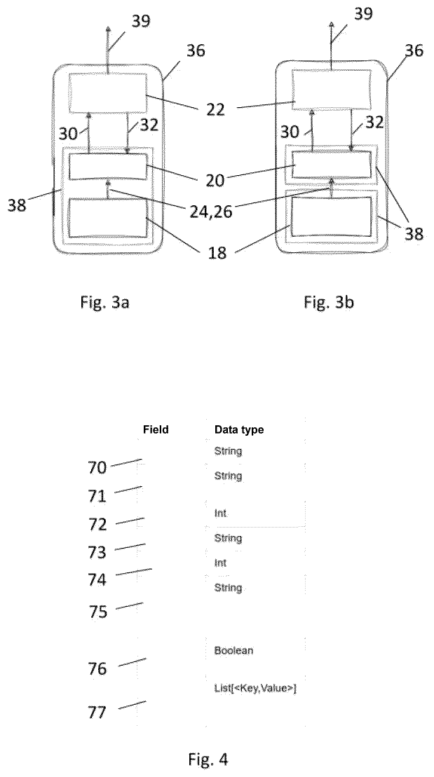

FIG. 3a, b two embodiments of the invention;

FIG. 4 a structure of a heartbeat; and

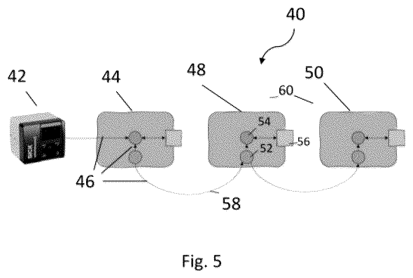

FIG. 5 a flowchart that illustrates one embodiment of the invention within a ROS application.

FIG. 1 shows an industrial machine 12, for example a robot, for securely processing data within a software container environment, wherein the industrial machine 12 comprises a data generating unit 14 for generating application data and a data processing unit 16 for processing the application data provided by the data generating unit 14 within the software container environment. The data generating unit 14 is connected via a connection 17 to the data processing unit 16 in order to transmit the application data to the data processing apparatus 16. The data processing unit 16, as a runtime environment, is configured to allow a plurality of logic modules 18-22 to run on the data processing unit. The logic modules 18-22 comprise an application module 18 for executing at least one application using the application data, wherein the application module 18 is configured to generate state data that are associated with the application, an adaptation module 20 that is configured to receive the state data from the application module 18 and to convert the state data into a format that is processable for a safety monitoring module 22, and the safety monitoring module 22 that is configured to receive the converted state data from the adaptation module 20 and to determine whether an error state exists on the basis of the converted state data. In response to determining an error state, the safety monitoring module 22 transmits a safety signal 39 to a control module, not shown, of the data processing apparatus 16 or to a control, not shown, of the industrial machine 12 that executes a safety action in response to the received safety signal 39. For example, the safety action can comprise returning the industrial machine 12 to a safe state. If the industrial machine 12 is, for example, a robot, the safety action can comprise: stopping the robot, restricting the radius of movement of the robot, and/or emitting a safety signal 39, e.g. an acoustic or visual safety signal 39.

FIG. 2 shows a flowchart that illustrates a mode of operation of one embodiment. The statements described above regarding FIG. 1 still apply, wherein FIG. 2 shows the processing procedure of the data in more detail.

In a first step, the processing procedure shown in FIG. 2 comprises the processing of state data packets, which are generated cyclically, i.e. at fixed, regular time intervals, by the application module 18, by an adaptation module 20. The state data packets contain data that indicate a state of an associated application and are suitable for determining whether an error state of the application exists that may be safety-critical. In the following, these state data packets are referred to as heartbeats 24,26. The adaptation module 20 receives two types of heartbeats 24,26: “Processing started” heartbeats 24 and “Processing completed” heartbeats 26. These two heartbeat types are generated within a cycle by the application module 18 and are sent to the adaptation module 20, wherein each cycle comprises exactly one heartbeat 24 of the “Processing started” type and one heartbeat 26 of the “Processing completed” type.

Each heartbeat 24,26 comprises respective data fields corresponding to a heartbeat ID 70, an application designation 71, a creation point in time 72 of the heartbeat 24,26, a verification sign 73, a sequence number 74, a type 75 of the heartbeat 24,26, a status 76 of the heartbeat 24,26, or an attribute 77 of the heartbeat 24,26, as shown in FIG. 4. Heartbeats 24,26 of the same cycle are in this respect assigned the same sequence number 74. The heartbeats 24,26 are received by the adaptation module 20 and stored in a queue 28. In the queue 28, the heartbeats 24,26 are stored chronologically, i.e. according to their point in time of arrival, wherein access to specific heartbeats 24, 28 based on their sequence number 74 is also possible. No direct processing of the heartbeats 24,26 takes place; rather, they are first collected and sorted in the queue 28.

The next step involves the safety monitoring module 22 that sends an action signal 30 to the adaptation module 20 via a previously opened interface. This action signal 30 contains a processing ID and a sequence number 75, on the basis of which the adaptation module 20 selects the corresponding heartbeats 24, 26 from the queue 28. A check 34 of the heartbeats 24,26 is then carried out. This check 34 comprises a preliminary check in which the completeness of the heartbeats 24,26 is checked that are associated with the sequence number 74 contained in the action signal 30. Here, a distinction is made between three possible scenarios:

1. All the heartbeats associated with the sequence number are present: Since it is already known in advance that each cycle comprises exactly two heartbeat types 75, i.e. a “Processing started” heartbeat 24 and a “Processing completed” heartbeat 26, two heartbeats 24, 26 must be present for each sequence number 74. If two heartbeats 24,26 are present for a respective sequence number 74, the adaptation module 20 can start an evaluation of the heartbeats 24,26 directly and can send the evaluation result together with the processing ID and the sequence number 74 in an evaluation data packet 32 to the safety monitoring module 22.

2. No heartbeat is present: If no heartbeat 24,26 is present for a sequence number 74, the adaptation module 20 waits for a predefined time period or a predefined number of cycles, stores corresponding metadata in a buffer and sends a standby signal to the safety monitoring module 22, wherein the standby signal indicates that the heartbeats 24,26 that are associated with the sequence number 74 specified in the action signal 30 have not yet been completely processed. If the heartbeats 24,26 arrive within the tolerated time period or cycles, the evaluation is performed “normally”; otherwise, the adaptation module 20 identifies the processing as failed and sends a corresponding signal to the safety monitoring module 22.

3. Not all the heartbeats are present: The procedure in such a case largely corresponds to the procedure in the case in which no heartbeat 24,26 is present, wherein, in contrast thereto, the present heartbeat 24,26 and the metadata are stored in the buffer.

If the adaptation module 20 receives the action signal 30 from the safety monitoring module 22 and it has been determined that all the expected heartbeats 24,26 are present, the evaluation begins.

The evaluation of the heartbeats 24,26 in this respect comprises the following checks:
Plausibility check of the heartbeats: Here, the adaptation module 20 checks the correctness of the heartbeats 24,26. On the one hand, the checksum of the heartbeat 24,26 is checked. For this purpose, a comparison checksum for the heartbeat 24,26 is determined using the data of the heartbeat 24,26. The comparison checksum is in this respect generated under the same rules as the checksum stored in the heartbeat 24,26. The determined comparison checksum is compared with the checksum stored in the heartbeat 24,26, wherein the plausibility check is deemed to have failed if the comparison checksum and the stored checksum do not match. In addition, a plausibility of the creation point in time 72 of the heartbeat 24,26 is checked. Such a check comprises a check of the conclusiveness of the creation point in time 72 or of the timestamp of the state data packet. In particular, it is checked whether the creation point in time 72 does not have a negative value and/or whether the time base of the creation point in time 72 matches the time base used by the adaptation module 20. If the check of the plausibility of the creation point in time 72 is negative, i.e. if the creation point in time 72 has a negative value and/or the time base of the creation point in time 72 does not match that of the time base used by the adaptation module 20, this represents, for example, an error state and the plausibility check is deemed to have failed. Finally, it is checked whether the number of heartbeats 24,26 corresponds to the predefined number of heartbeats 24,26 within a cycle or whether the number of heartbeats 24,26 exceeds the predefined number, wherein the plausibility check is deemed to have failed if the number of heartbeats 24,26 exceeds the predefined number. If at least one of the above checks is not successful, the plausibility check is deemed to have failed.
Check of the status of the heartbeats 24,26: The adaptation module 20 is configured to analyze the field for the status 76 of the heartbeats 24,26, i.e. the health of the transmitter or of the application module 18, wherein the status 76 indicates either “true” (positive) or “false” (negative). All the statuses 76 of the heartbeats 24,26 are combined by means of a logical AND operation to obtain the final evaluation result for the given sequence number 74. This means that the evaluation result is positive if all the statuses 76 of the heartbeats 24,26 are “true” and negative as soon as one of the statuses 76 of the heartbeats 24,26 is “false”. In addition, depending on the application, the data contained in the data field attribute 77 of the heartbeats 24,26 can be used for the evaluation, for example, specific status codes that are used by the application module 18.

After the evaluation, the evaluation result is converted together with a safety header as an evaluation data packet 32 into a format which the safety monitoring module 22 “understands” or can process. These data are then sent via the provided interfaces to the safety monitoring module 22 that then integrates said data into the security infrastructure 60 of the container orchestration runtime environment. This process ensures that the heartbeats 24,26 are evaluated correctly and reliably and that appropriate measures can be taken in the event of errors. For example, in response to the identification of an error state, a safety signal 39 is transmitted from the safety monitoring module 22 to a controller in order to initiate a safety action. The security infrastructure 60 of the container orchestration runtime environment, for example, represents a specialized infrastructure or architecture that ensures the security and compliance requirements in distributed systems.

FIGS. 3a and 3b show two different embodiments of the invention. The application module 18, the adaptation module 20 and the safety monitoring module 22 are shown in FIGS. 3a and 3b within the Kubernetes ecosystem as part of a Kubernetes pod 36, i.e. as part of an application component.

In FIG. 3a, however, the application module 18 and the adaptation module 20 are implemented on the same container 38, wherein the adaptation module 20 and the application module 18 use the same software technologies. For example, the application module 18 and the adaptation module 20 use the same framework, system, the same programming library or programming paradigm and/or the same data structures and data types. This variant has the advantage that no complex adaptation mechanisms need to be implemented between the adaptation module 20 and the application module 18 since the two modules are already implemented on the same container 38 and are thus based on the same software technologies.

On the other hand, the application module 18 and the adaptation module 20 in FIG. 3b are implemented on different containers 38, wherein the adaptation module 20 is adapted to the software technologies used by the application module 18 by means of adaptation mechanisms such as RPC (Remote Procedure Call). This variant has the advantage of increased resilience if a plurality of application modules 18 use the same adaptation module 20 or exchange data with the same adaptation module 20. Furthermore, this variant can be implemented with less overhead and less latency.

FIG. 4 illustrates a structure of a heartbeat 24,26, wherein the heartbeat 24,26 comprises the following data fields: a heartbeat ID 70 of a string data type, an application designation 71 of a string data type, a creation point in time 72 of the heartbeat 24,26 of an Int data type, a verification sign 73 of a string data type, a sequence number 74 of an Int data type, a type 75 of the heartbeat 24,26 of a string data type, a status 76 of the heartbeat 24,26 of a Boolean data type, or an attribute 77 of the heartbeat 24,26 of a list data type.

FIG. 5 shows a flowchart that illustrates one embodiment of the invention within a ROS application 40.

In this respect, a ROS-supported system is used for processing and analyzing image data that are provided by a SICK safeVisionary2 camera 42 (sV2) in the present case. The system consists of a plurality of ROS nodes that work together to recognize and count persons in a defined region. The ROS nodes correspond, for example, to the above-described modules and are independent programs or processes in a ROS system. These ROS nodes are deployed in Kubernetes containers 38 as Kubernetes pods 36, wherein all the messages within the ROS system are managed via an internal ROS messaging system. In this respect, ROS in particular serves for connecting the sV2 camera, for defining messages and for distributing messages within ROS.

The processing chain in the system begins with a sensor port pod 44 that collects data from the sV2 camera. The collected sensor data are provided via so-called ROS topics 46 and are thus available in the entire ROS ecosystem. ROS topics 46 are communication channels in a ROS network that enable the exchange of messages between ROS nodes. In a ROS system, different nodes can communicate with one another by publishing or subscribing to messages on these ROS topics. The raw data filter pod 48 is responsible for filtering the incoming raw data before they are processed further. Via the object recognition pod 50, the person recognition is subsequently carried out and the number of persons in a defined region is determined.

Each Kubernetes pod 36 comprises a respective ROS application node 52, a ROS adaptation node 54 and a safety watcher 56, i.e. a safety monitoring node, wherein a respective Kubernetes pod 36 is deployed as a container 38. Furthermore, the safety watcher 56 is implemented in a separate container 38. Therefore, the adaptation module 20 is itself a ROS node, namely the ROS application node 52 that interacts seamlessly with the ROS messages and their formats.

In the following, the processing procedure of a Kubernetes pod 36 is described purely by way of example with reference to the raw data filter pod 48, wherein the statements can be transferred to the other Kubernetes pods. The terms ROS application node 52, ROS adaptation node 54 and safety watcher 56 thus refer below to the respective nodes of the raw data filter pod 48, unless the description indicates otherwise.

The ROS application node 52 receives messages 58 from the preceding ROS application node 52, i.e. from the preceding pod, via the internal ROS messaging system. After receiving a message 58, the ROS application node 52 starts the processing and sends a “Processing started” heartbeat 24 and a “Processing completed” heartbeat 26 to the corresponding ROS adaptation node 54, i.e. to the raw data filter adaptation node. Since the adaptation node is likewise a ROS node and the heartbeats 24,26 are defined as ROS message types, it is able to receive and process these heartbeats 24,26. The heartbeats 24, 26 can, for example, have a structure as shown in FIG. 4.

The ROS adaptation node 54 receives the heartbeats 24,26 and stores them in a map that serves as a queue 28. This map has the structure Map<Sequence number, List[Heartbeat]>, whereby heartbeats 24,26 can be sorted according to their sequence number 74 and can be deliberately called up as required. In this respect, it is ensured that the heartbeats 24,26 are processed chronologically and correctly.

Parallel to the processing by the ROS adaptation node 54, the processing takes place via a security infrastructure 60 of the container orchestration runtime environment. In this respect, the safety watcher 56 of the previous pod sends a safety watcher signal in the form of a safety header via the security infrastructure 60, which safety header is picked up by the safety watcher 56 of the current pod and forwarded to the ROS adaptation node 54. This safety header contains a sequence number 74, a processing ID and a checksum that was calculated in the preceding ROS adaptation node 54 on a payload of the data, i.e. on the use data. For example, this is an application-specific payload from the general description of the data. The transfer of the safety header, for example, takes place via a gRPC streaming connection that was opened on an initialization of the ROS adaptation node 54.

The ROS adaptation node 54 receives the signal from the safety watcher 56 and accesses the associated heartbeats 24,26 stored in the queue 28 based on the sequence number 74. The following checks are then carried out: First, it is checked whether all the expected heartbeats 24,26 are present. For example, a completeness check described above is carried out for this purpose. If heartbeats 24,26 are missing, this leads directly to a negative evaluation, i.e. a tolerance period is not provided for heartbeats 24,26 that are not present. The ROS adaptation node 54 then compares the checksum sent by the safety watcher 56 signal with the checksum that is contained in the “Processing started” heartbeat 24. The checksum can, for example, be stored in an attribute field 77 of the heartbeat 24,26. In addition, the status 76 of the heartbeats 24,26 is checked, wherein a positive status 76 can be signaled by a status value ‘HEALTH_OK’.

If one of the checks mentioned is negative, the ROS adaptation node 54 immediately sends a negative evaluation message, i.e. an evaluation data packet 32 that indicates an error state, to the safety watcher 56. This marks the point in time at which the ROS system is exited and the regular monitoring and/or safety mechanisms of the security infrastructure 60 of the container orchestration runtime environment are applied. Overall, this approach ensures that the security and reliability of the system processing are guaranteed by enabling a precise monitoring and validation of the heartbeats 24,26 and an accurate response to security incidents.

### Reference Numeral List

12 industrial machine
14 data generating unit
16 data processing unit
17 connection
18 application module
20 adaptation module
22 safety monitoring module
24 “Processing started” heartbeat
26 “Processing completed” heartbeat
28 queue
30 action signal
32 evaluation data packet
34 check
36 Kubernetes pod
38 container
39 safety signal
40 ROS application
42 safeVisionary2 camera
44 sensor port pod
46 ROS topics
48 raw data filter pod
50 object recognition pod
52 ROS application node
54 ROS adaptation node
56 safety watcher
58 message
60 security infrastructure
70 heartbeat ID
71 application designation
72 creation point in time
73 verification sign
74 sequence number
75 type
76 status
77 attribute

1. An apparatus for use in an industrial environment for the secure processing of data within a software container environment, said apparatus comprising:
a data generating unit for generating application data,
a data processing unit for processing the application data provided by the data generating unit within the software container environment, wherein the data processing unit, as a runtime environment, is configured to allow a plurality of logic modules to run on the data processing device, wherein the logic modules comprise:
at least one application module for executing at least one application using the application data, wherein the first application module is configured to generate state data that are associated with the application,
an adaptation module that is configured to receive the state data from the application module and to convert the state data into a format that is processable for a safety monitoring module,
the safety monitoring module that is configured to receive the converted state data from the adaptation module and to determine whether an error state exists on the basis of the converted state data.

2. The apparatus according to claim 1, wherein the industrial environment is an industrial machine.

3. The apparatus according to claim 1,
wherein the application module, the adaptation module and the safety monitoring module are designed as part of an application component.

4. The apparatus according to claim 1,
wherein the application component is an independent application component.

5. The apparatus according to claim 3,
wherein the application module, the adaptation module and/or the safety monitoring module access the same resources.

6. The apparatus according to claim 1,
wherein the application module and the adaptation module are implemented on the same container, wherein the adaptation module and the application module use the same software technologies.

7. The apparatus according to claim 1,
wherein the application module and the adaptation module are implemented on different containers, wherein the adaptation module is adapted to the application module by means of adaptation mechanisms.

8. The apparatus according to claim 7x, wherein the adaptation module is adapted to the software technologies used by the application module.

9. The apparatus according to claim 1,
wherein the adaptation module communicates with a plurality of different application modules and/or is used for a plurality of different applications.

10. The apparatus according to claim 1,
wherein the state data comprise state data packets,
wherein a state data packet comprises at least one of the following: a state data packet ID, an application designation, a creation point in time of the state data packet, a verification sign, a sequence number, a type of the state data packet, a status of the state data packet or an attribute of the state data packet.

11. The apparatus according to claim 10,
wherein the application module is configured to generate the state data packets cyclically, wherein a predefined number of state data packets are generated within a cycle, wherein the state data packets of a same cycle have the same sequence number.

12. The apparatus according to claim 9,
wherein the adaptation module is configured to arrange the state data packets in a queue in an order that corresponds to the chronological arrival of the state data packets.

13. The apparatus according to claim 9,
wherein the adaptation module is configured, in response to an action signal that is received from the safety monitoring module and that comprises a processing ID, a sequence number and/or a verification sign, to check the state data packets that are associated with the sequence number stored in the action signal.

14. The apparatus according to claim 13,
wherein the check comprises a preliminary check, wherein the preliminary check comprises:
a first completeness check, wherein the completeness check is positive if a predefined number of associated state data packets are present for the sequence number, and negative if fewer than the predefined number of state data packets are present for the sequence number,
wherein, in the event of a positive first completeness check, an evaluation of the state data packets takes place,
wherein, in the event of a negative first completeness check, a predefined time period is waited until a second completeness check takes place,
wherein, in the event of a positive second completeness check, an evaluation of the state data packets takes place,
wherein, in the event of a negative second completeness check, the adaptation module is configured to send an error signal in a format that is readable for the safety monitoring module to the safety monitoring module.

15. The apparatus according to claim 13,
wherein the check of the state data comprises an evaluation, wherein the evaluation comprises:
a plausibility check of at least one of the state data packets and/or a status check of at least one of the state data packets,
wherein the adaptation module is configured, in the event of a failed plausibility check and/or a failed status check, to send an evaluation data packet in a format that is readable for the safety monitoring module to the safety monitoring module, wherein the evaluation data packet indicates an error state.

16. The apparatus according to claim 15,
wherein the plausibility check of at least one of the state data packets comprises the following checks:
a check of the verification sign of the state data packet, which check comprises determining a comparison verification sign for a state data packet using the data of a state data packet and comparing the determined comparison verification sign with the verification sign of the state data packet,
a check of a plausibility of the creation point in time of the state data packet and/or
a check whether the number of state data packets exceeds or falls below a predefined number,
wherein the plausibility check is deemed to have failed if at least one of the checks included in the plausibility check fails for at least one of the state data packets.

17. The apparatus according to claim 15,
wherein the status check comprises:
checking the status of the state data packets, wherein the status check is deemed to have failed if at least one of the state data packets has a “failed” status.

18. A safety method for the secure processing of data within a software container environment, wherein the method comprises that:
application data are generated by a data generating unit,
on a data processing unit for processing the application data provided by the data generating unit within the software container environment, a plurality of logic modules run on the data processing device, wherein the logic modules comprise an application module, an adaptation module and a safety monitoring module,
state data that are associated with an application are generated by the application module,
the state data are received by the adaptation module and the state data are converted into a format that is processable for a safety monitoring module,
wherein the converted state data are received by the safety monitoring module and, on the basis of the converted state data, it is determined whether an error state exists.

19. A computer readable storage medium comprising commands that, on the execution by a computer, cause it to carry out the safety method according to claim 18.
